(19) United States
(12) Patent Application Publication
(10) Pub. No.: US 2007/0056887 A1
(43) Pub. Date: Mar. 15, 2007

(54) Sorting device

(76) Inventors: Robert Neuhold, Gleisdorf (AT); Reinhold Huber, Furstenfeld (AT)

Correspondence Address: WILLIAM COLLARD;COLLARD & ROE, P.C., 1077 NORTHERN BOULEVARD, ROSLYN, NY, 11576, US

(21) Appl. No.: 11/505,016

(22) Filed: Aug. 16, 2006

(30) Foreign Application Priority Data
Aug. 17, 2005 (AT) GM 561/2005

(51) Int. Cl. B07C 5/24

(52) U.S. Cl. 209/646; 209/639; 209/147; 239/551

(57) ABSTRACT

A device for blowing against individual pieces of a material flow conveyed via a freefall path or a link conveyor using a gaseous or liquid medium, comprising at least one connection opening (9) for the gaseous or liquid medium, as well as multiple blowing nozzles (16), via which the gaseous or liquid medium is blown in a controlled way on predetermined individual pieces of the material flow, as well as valves, preferably solenoid valves, assigned to the blowing nozzles (16), through which the blowing procedure is triggered and stopped, a flow channel being provided between each blowing nozzle (16) and the valve seat (19) of the valve assigned to a blowing nozzle (16), which only causes a single deflection of the gaseous or liquid medium. In order to allow optimum positioning of the valves and keep the pressure loss low, the valve plunger (5) of the valve is situated essentially perpendicularly to the blowing nozzle (16) or encloses an acute angle α with the axis of the blowing nozzle (16).

Applicants claim priority under 35 U.S.C. §119 of Austrian Application No. GM 561/2005 filed Aug. 17, 2005.

The present invention relates to a device for blowing against individual pieces of a material flow conveyed via a freefall path or a link conveyor using a gaseous medium, comprising at least one inlet opening for the gaseous medium, as well as multiple blowing nozzles, via which the gaseous medium is blown in a controlled way on predetermined individual pieces of the material flow, as well as valves assigned to the blowing nozzles, preferably solenoid valves, through which the blowing procedure is triggered and stopped.

Such devices are used in sorting machines for transparent and nontransparent bulk goods such as metals, plastics, and stones, as well as glass, paper, or cardboard. They preferably operate using optical or inductive transmitter and receiver units and are used for the purpose of removing foreign bodies located in the material flow from the material flow or conveying different types of the material of the material flow into different containers.

Such a sorting machine is known, for example, from AT 395,545 B. The transmitter units comprise light sources, preferably diode light sources, emitting light beams, for example, which are bundled in the receiver unit onto a photocell via a lens system.

However, embodiment variations in which color cameras are used as the receiver units and typical light sources such as fluorescent tubes function as light sources, for example, are also known.

Both transmitter and also receiver units are connected to a central computing unit, which processes the incoming data and allows the position, size, and type of the individual pieces located in the material flow to be detected on the basis of the light beams incident on the receiver unit and emitted by the transmitter units.

Furthermore, the sorting of the individual pieces is performed as a function of the completed detection of the individual pieces in the material flow. This is performed in a way known per se by blowing against the individual pieces using a gaseous or liquid medium, such as compressed air or water, during their freefall or during their transport on a link conveyor through the gaps of the link conveyor, through which these pieces may be deflected from their flight path or from the material flow lying on the link conveyor into a container provided for this purpose.

In known sorting machines, a component containing the blowing nozzles and the flow channels leading to the blowing nozzles is used as the blowing device, to which commercially available solenoid valves are coupled, preferably screwed on, through which the valve outlet opening(s) is/are connected to corresponding intake openings of the component provided on the component in order to produce a connection to the blowing nozzles.

The solenoid valves may not be coupled to the component containing the blowing nozzles in any arbitrary way. A typical solenoid valve normally comprises a valve plunger as well as a return spring, for returning the valve plunger, as well as an electromagnet which causes the opening movement of the valve plunger. Because of the mode of operation of the valve, restoring spring and electromagnet are each situated on different sides of the valve plunger in relation to its axis. Only a very restricted possibility of situating the solenoid valve on the component containing the blowing nozzles thus results.

When such known blowing devices are used, it has been shown that because of the coupled construction, the response behavior or, in other words, the reaction time of the blowing nozzles is in need of improvement. This is caused by the long flow channels which result because of the connection of commercially available solenoid valves to the component having the blowing nozzles. Overall, long flow channels leading from the valve to the blowing nozzle thus result, which causes large pressure losses and thus from the beginning requires a higher starting pressure for exact blowing against the individual pieces in the material flow and, in addition, also results in long “after blowing” after the valve is turned off, which not only causes increased consumption of the gaseous medium, but also a reduction of the sorting efficiency of the sorting device.

However, it is not only the length which causes the pressure loss in the known blowing devices, but rather also the required number of deflections which the gaseous medium passes through in order to reach from the valve seat to the blowing nozzles and which result because of the limited connection possibilities of the commercially available solenoid valve to the component having the blowing nozzles. Each individual deflection causes an additional pressure loss. If one considers that the gaseous medium used until now in the present technical field is compressed air, a financial disadvantage also results in typical blowing devices, since compressed air represents one of the most expensive operating materials and a reduction of the compressed air demand and the required pressure thus not only provides technical advantages, such as smaller components and shorter reaction times, but rather also makes savings of a financial type possible due to the lower consumption of compressed air.

A further disadvantage of the known blowing devices is the fact that multiple commercially available solenoid valves must be situated on the component having the blowing nozzles. Because of a required minimum flow volume, limits are set here in regard to the size of the valves. It is not possible to go below a minimum size tailored to the particular field of use. Each of the commercially available valves has its own housing having a wall thickness, however, so that valuable space on the component having the blowing nozzles is lost due to these wall thicknesses, because of which the number of usable valves on a component having the blowing opening is unnecessarily restricted. In addition, the commercially available valves may not be installed directly next to one another, in order to allow the circulation of cooling air on the valve housing.

A flow divider for ore sorting machines is known from DE 28 48 000 A1, ore stone chips being guided past blowing nozzles in freefall and selectively deflected. This flow divider is an oblong metal block having a polygonal cross-section, which has multiple faces on one side, each abutting one another at an obtuse angle, for receiving valves, the blowing nozzles being provided on a diametrically opposite, flat side of the metal block. The flow divider has a central flow medium supply line along its longitudinal axis, through which the valve chambers adjoining the faces of the object are fed via flow medium transmission lines situated in pairs. A flow channel extends from each of the valve chambers transversely through the entire metal block and through the flow medium supply line to the flow medium outlets. In order to achieve a linear row next to one another of the flow medium outlets along the metal block in spite of the angled arrangement of the valve chambers to one another, one of the flow medium outlet lines is implemented as linear and the other two are provided with a slight curvature. This blowing device is also designed as very complex in regard to the complicated feeding of the valve chambers using the paired flow medium transmission lines, including the 180° deflection of the flow medium in the direction of the flow channel in case of a discharge nozzle actuation, occupies a large amount of space, and still causes a significant friction and/or pressure loss of the system. In particular the long flow channels, which are guided through the cross-section of the central flow medium supply lines and are subjected there to abrasion by the flow medium, have been shown to be disadvantageous in the present field of application.

It is therefore the object of the present invention to avoid the disadvantages described and to provide a device of the type cited at the beginning which allows a reduction of the reaction time of the blowing device while simultaneously lowering the required pressure and reducing the pressure losses occurring.

It is a further object of the present invention to provide a device of the type cited at the beginning which reduces the space required by the valve and thus allows more valves to be situated than in the blowing devices known from the prior art, with the overall space required remaining the same.

A further object of the present invention is the reduction of the piece count which is required for manufacturing such a blowing device.

These objects are achieved according to the present invention by the characterizing features of claim 1.

A device for blowing against individual pieces of a material flow conveyed via a freefall path or a link conveyor using a gaseous or liquid medium comprises blowing nozzles including assigned valves, a flow channel being provided between each blowing nozzle and the valve seat of the valve assigned to a blowing nozzle which only causes a single deflection of the gaseous or liquid medium.

Because, according to the present invention, the valve plunger of the valve is situated essentially perpendicularly to the blowing nozzle or encloses an acute angle α with the axis of the blowing nozzle, a space-saving variation, whose construction is especially easy to implement, of a blowing device according to the present invention is suggested, while simultaneously meeting the requirement that the operating medium must only be deflected one time on its path from the valve seat to the blowing nozzle. In a preferred embodiment variation, the valve plunger of the valve encloses an acute angle α with the axis of the blowing nozzle, in order to be able to deal with the existing space conditions better and make the accessibility to the device easier.

In such a way, the pressure loss remains low and the reaction time may also be kept accordingly low. Optimum situation of the valves is thus also possible.

According to the characterizing features of claim 2, the blowing device according to the present invention is operated using compressed air or water.

The characterizing features of claim 3 provide that multiple blowing nozzles are assigned to one valve. The number of blowing nozzles determines the resolution or the precision with which the individual pieces may be blown out of the material flow. By activating multiple blowing nozzles using one valve, simplified activation is possible.

According to the characterizing features of claim 4, precisely one blowing nozzle is assigned to each valve. This embodiment variation allows the highest resolution or blowing precision at a given number of blowing nozzles.

According to the characterizing features of claim 5, the blowing nozzles, the valve plunger including the valve seat, as well as the at least one inlet opening, as well as the flow channels which produce a connection between the particular valve seats and the particular blowing nozzles, are housed in a single housing. An especially compact construction of a blowing device according to the present invention may thus be achieved. The wall thicknesses of the commercially available solenoid valves are dispensed with completely, so that significantly less space is required with the same flow output of the valves.

According to a further preferred embodiment variation of the present invention, as described in claim 6, the blowing nozzles are covered by a replaceable strip which has eccentric or concentric holes to the blowing nozzles. Abrasions and contamination which result through contact of the blowing device with the material flow are thus not able to negatively influence the functional capability of the blowing device according to the present invention since, before such a state occurs, the strip may be replaced by a new one. The actual blowing nozzles situated in the housing are neither abraded nor contaminated. Through the eccentric situation of the holes, the medium used may be distributed along the strip after leaving the blowing nozzles without increasing the number of the blowing nozzles, through which the blowing resolution may be elevated overall.

According to the characterizing features of claim 7, at least for a defined number of blowing nozzles, the distance between the opening of a blowing nozzle and the assigned valve seat is at most 16 mm. Depending on the size of the blowing device, an especially short reaction time may thus be provided depending on the size of the blowing device, at least for a defined number of blowing nozzles.

In the following, the present invention will be described in greater detail on the basis of the drawing.

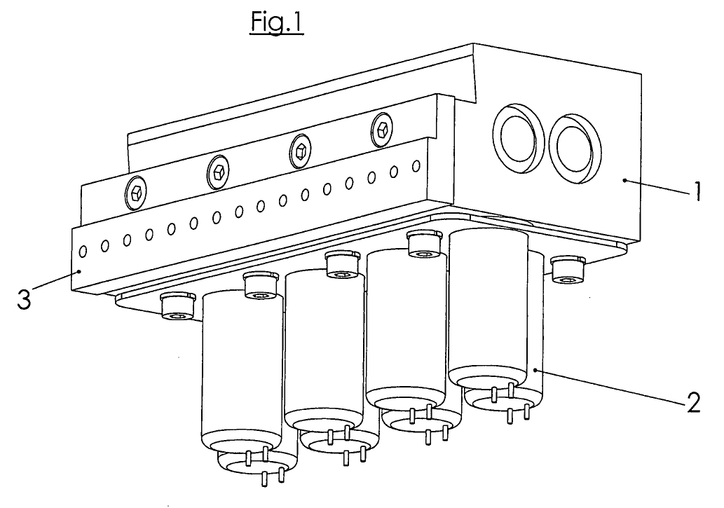

FIG. 1 shows an axonometric view of a blowing device according to the present invention

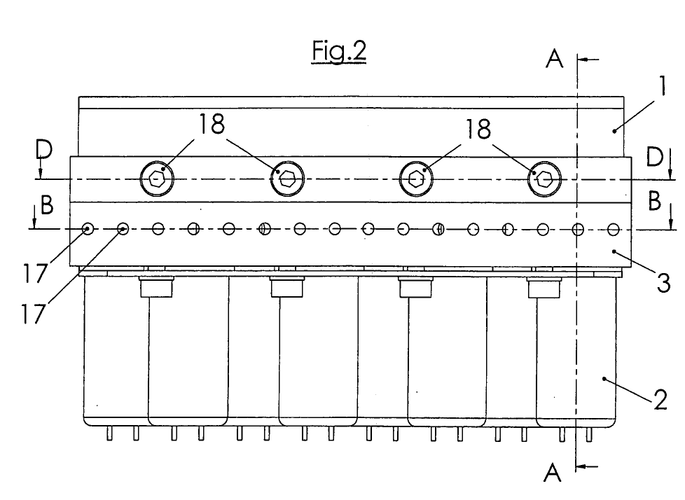

FIG. 2 shows a frontal view of a blowing device according to the present invention

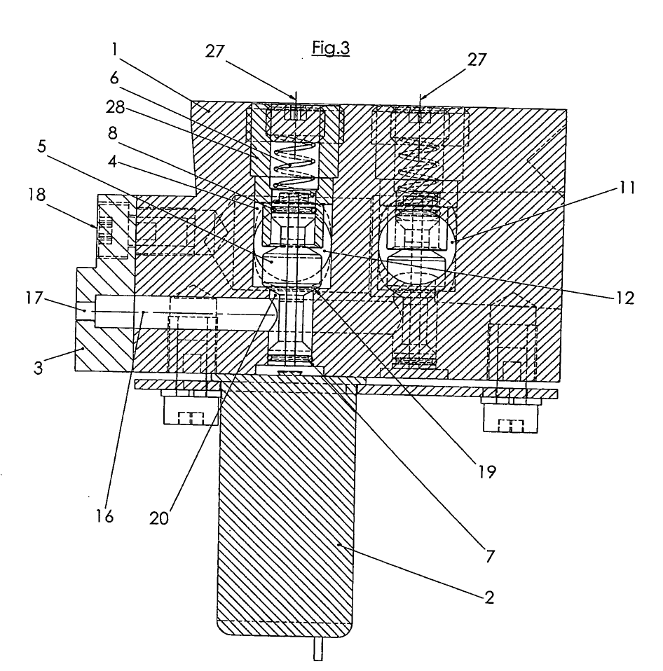

FIG. 3 shows a sectional view of a blowing device according to the present invention along line A-A from FIG. 2

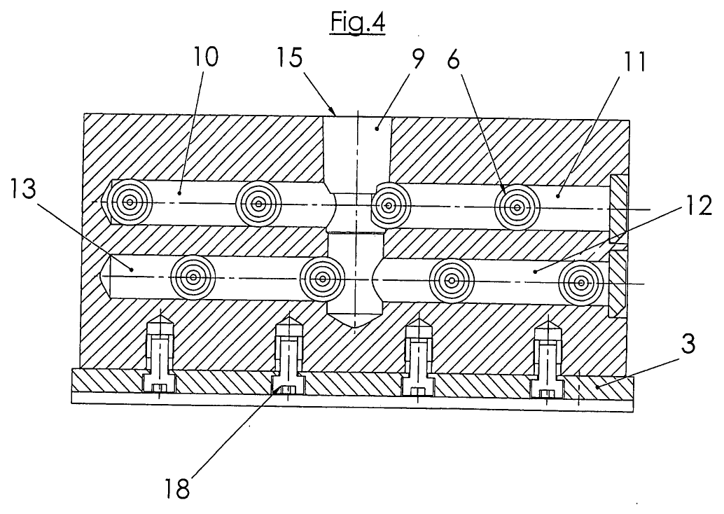

FIG. 4 shows a sectional view of a blowing device according to the present invention along line D-D from FIG. 2

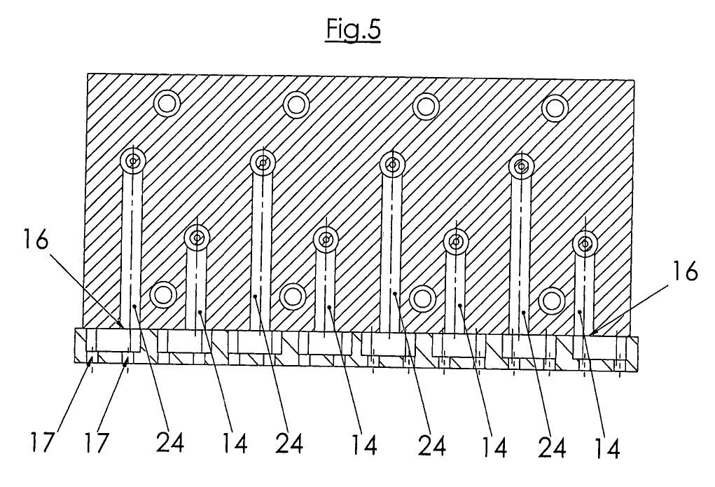

FIG. 5 shows a sectional view of a blowing device according to the present invention along line B-B from FIG. 2

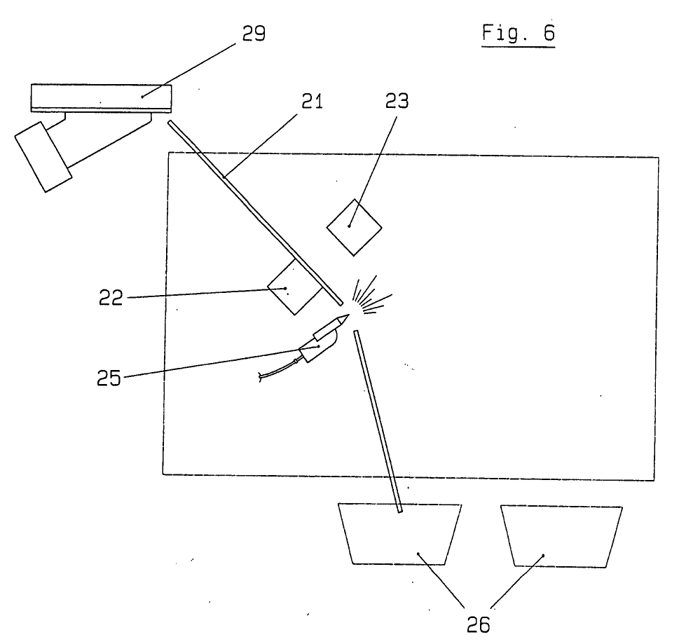

FIG. 6 shows a schematic illustration of a sorting device known from the prior art

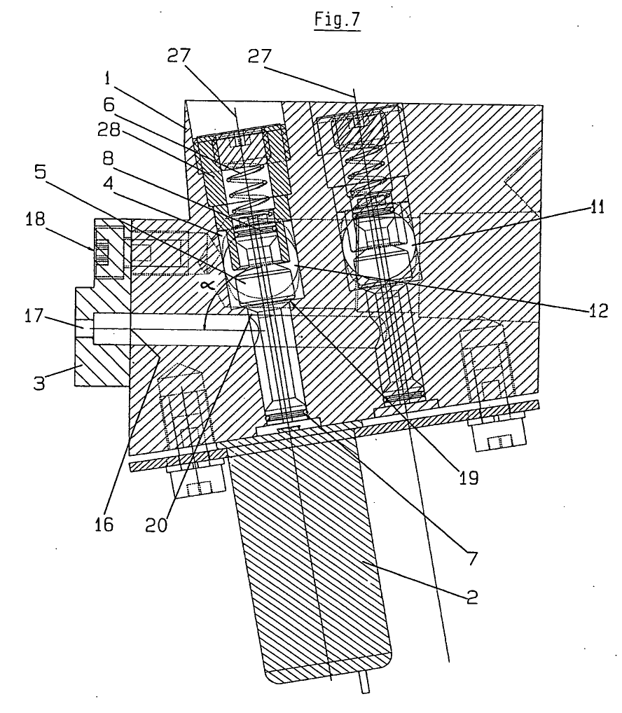

FIG. 7 shows a sectional view of an alternative embodiment of a blowing device according to the present invention

FIG. 1 shows an axonometric view of a blowing device according to the present invention. This comprises a housing 1, on which electromagnets 2 are supported, as well as a replaceable strip 3, which will be discussed in greater detail below.

The housing is preferably manufactured from aluminum. Alternative materials such as steel, Nirosta stainless steel, brass, or plastic may, however, also be used.

FIG. 2 shows a frontal view of the blowing device according to the present invention in the viewing direction toward the strip 3.

As may be seen in FIG. 3, which shows a sectional view along line A-A from FIG. 2, the housing 1 has multiple cavities 4, each of which is used for receiving a valve, in its interior.

Each valve is constructed from a valve plunger 5 and a return spring 6. Furthermore, two seals (O-rings) 7, 8, as well as a buttress 28, form components of the valve, in addition to the electromagnet 2, which is situated outside the housing 1 and causes the motion of the valve plunger 5.

Furthermore, the housing 1 has inlet flow channels 9, 10, 11, 12, 13 (see FIG. 4), via which the gaseous operating medium, preferably compressed air, is conducted from a connection opening 15 to the valves, as well as flow channels 14, 24 (see FIG. 5), which lead from the particular valve seats 19 to the assigned blowing nozzle 16. These flow channels are composed of a section which forms the blowing nozzles 16 and a section 20 which directly adjoins the valve seat 19 and thus, viewed from the blowing nozzle 16, runs after the deflection from the deflection up to the valve seat 19.

A strip 3 is situated in front of the blowing nozzles 16, which is replaceably connected to the housing 1 via screws 18. The strip 3 has holes 17, which are situated eccentrically to the blowing nozzles 16 in the mounted position of the strip 3, so that the medium leaving the blowing nozzles 16 may be distributed along the strip 3, through which the blowing resolution is increased.

Alternatively, the holes 17 may also be situated concentrically to the blowing nozzles 16, due to which the number of the holes 17 remains restricted to the number of the blowing nozzles 16, however.

Each flow channel 14, 24 between the blowing nozzles 16 and the valve seat 19 has only one single deflection, which is formed by the transition from the section of the flow channel 14, 24 forming a blowing nozzle 16 into the section of the flow channel 14, 24 directly adjoining the valve seat 19. Pressure losses and reaction times may be reduced because the gaseous operating medium only experiences a single change of direction. Simultaneously, it is ensured by positioning the valve plunger 5 essentially perpendicularly to the blowing nozzles 16 according to the present invention that the valve may be installed with a very simple construction in the housing 1, the required electromagnets 2 and the return spring 6 being situated on different sides of the valve plunger 5 in relation to the axis.

FIG. 6 shows a schematic illustration of a sorting device known from the prior art, in which generic blowing devices are used. A chute 21 adjoining a feed station 29 is provided, in whose lower area a detector unit, which comprises transmitter units 22 and receiver units 23, as well as a central computing unit (not shown), is situated to detect individual pieces in the material flow. This detector unit controls a blowing device 25 situated at the end of the chute 21, which is situated below the material flow, which follows the course of a parabolic trajectory in this area, and deflects the desired individual pieces (foreign bodies, foreign materials, etc.) upward upon activation, so that these are conveyed into the container(s) 26 provided for this purpose.

FIG. 7 shows a sectional view of an alternative embodiment of a blowing device according to the present invention. The essential features thereof correspond to those of the device shown in FIG. 5, but with the difference that the valve axis 27 or the valve plunger 5 encloses an acute angle α with the axis of the blowing nozzles 16, α being able to be both positive and also negative, i.e., in FIG. 7, the valve plunger 5 may incline to the left or to the right. Depending on the space required, the installation of the device according to the present invention may be made easier in this way.

The mode of operation of the blowing device according to the present invention is as follows:

The operating medium is conducted into the housing 1 via the connection opening 15, where it is first distributed further via the inlet flow channel 9 into the inlet flow channels 10, 11, 12, and 13 until it has reached the particular valve seat 19 of the individual valves. These are closed at this point in time, i.e., each valve plunger 5 seals tightly with the valve seat 19. As a function of a control signal of a central computing unit, which is in turn based on detection of individual pieces in the material flow to be sorted out, the electromagnets 2 are activated, due to which the valve plungers 5 move and open the valve. The gaseous operating medium may now flow to the blowing nozzles 16, it being deflected once.

1. A device for blowing against individual pieces of a material flow conveyed via a freefall path or a link conveyor using a gaseous or liquid medium, comprising at least one connection opening (9) for the gaseous or liquid medium, as well as multiple blowing nozzles (16), via which the gaseous or liquid medium is blown in a controlled way on predetermined individual pieces of the material flow, as well as valves, preferably solenoid valves, assigned to the blowing nozzles (16), through which the blowing procedure is triggered and stopped, a flow channel being provided between each blowing nozzle (16) and the valve seat (19) of the valve assigned to a blowing nozzle (16), which only causes a single deflection of the gaseous or liquid medium, characterized in that the valve plunger (5) of the valve is situated essentially perpendicularly to the blowing nozzle (16) or encloses an acute angle α with the axis of the blowing nozzle (16).

2. The device according to claim 1, characterized in that the gaseous/liquid medium is compressed air/water.

3. The device according to claim 1 or 2, characterized in that multiple blowing nozzles (16) are assigned to one valve.

4. The device according to one of claims 1 through 2, characterized in that one blowing nozzle (16) is assigned to each valve.

5. The device according to one of claims 1 through 4, characterized in that the blowing nozzles (16), the valve plunger (5) together with valve seat (19), as well as the at least one connection opening (9) and the flow channels, are housed in a single housing.

6. The device according to one of claims 1 through 5, characterized in that the blowing nozzles (16) are covered by a replaceable strip (3), which has eccentric or concentric holes (17) to the blowing nozzles (16).

7. The device according to one of claims 1 through 6, characterized in that, at least for a defined number of blowing nozzles (16), the distance between the opening of a blowing nozzle (16) and the assigned valve seat (19) is at most 16 mm.
